(19) United States
(12) Patent Application Publication
(10) Pub. No.: US 2026/0295535 A1
(43) Pub. Date: Oct. 1, 2026

(54) GAS SEPARATION MEMBRANE MODULE ASSEMBLY

(71) Applicant: HONDA MOTOR CO., LTD., Tokyo (JP)

(72) Inventor: Yuki Shibahata, Wako-shi (JP)

(21) Appl. No.: 19/542,970

(22) Filed: Feb. 18, 2026

(30) Foreign Application Priority Data
Mar. 27, 2025 (JP) 2025-053420

(51) Int. Cl. B01D 63/08; B01D 53/22

(52) U.S. Cl. CPC B01D 63/082; B01D 53/226; B01D 2053/222; B01D 2257/504

(57) ABSTRACT

A gas separation membrane module assembly in which a plurality of flat separation membrane substrates and gas separation membranes are stacked via vacuum plates and seal rings, wherein a flow path forming member is provided, the flow path forming member being connected to both ends of one surface of the separation membrane substrate and having an opening portion which forms a gas flow path that extends in a direction approximately perpendicular to the one surface of the separation membrane substrate, and the vacuum plate and the seal ring are stacked on the flow path forming member so as to surround the opening portion.

### CROSS-REFERENCE TO RELATED APPLICATION

Priority is claimed on Japanese Patent Application No. 2025-053420, filed Mar. 27, 2025, the content of which is incorporated herein by reference.

### BACKGROUND OF THE INVENTION

### Field of the Invention

The present invention relates to a gas separation membrane module assembly.

### Description of the Related Art

Due to the use of fossil fuels such as oil and coal, exhaust gases emitted from factories contain carbon dioxide. From the perspective of carbon neutrality, it is desirable to reduce carbon dioxide emissions from factories. Methods for separating and capturing carbon dioxide contained in exhaust gases include, for example, an amine absorption method, a physical adsorption method, a membrane separation method, and the like. Among them, the membrane separation method using a gas separation membrane has attracted attention because of its low cost and ease of implementation.

In the membrane separation method, a vacuum pump is used to create a pressure difference between a front surface and a back surface of a gas separation membrane, thereby allowing carbon dioxide to selectively pass through. Because the membrane separation method does not require thermal energy, it can separate carbon dioxide at low cost.

There is known a gas separation membrane module used in the membrane separation method, including a stacked body in which a plurality of gas separation membranes are stacked, pressure-resistant plates disposed on both sides of the outermost surface of the stacked body in a stacking direction, and fastening units disposed in the stacking direction to fasten the pressure-resistant plates together (refer to, for example, PCT International Publication No. WO 2016/136048).

### SUMMARY OF THE INVENTION

However, in a conventional gas separation membrane module, it was difficult to install bolts that could be fastened in a through-structure in a longitudinal direction of the gas separation membrane module due to concerns about gas leakage. When such bolts are not installed, uneven seal surface pressure will occur, which can lead to gas leakage.

An aspect of the present invention provides a gas separation membrane module assembly in which occurrence of uneven seal surface pressure is curbed and gas leakage is curbed. The aspect of the present invention contributes to energy efficiency.

The present invention has the following aspects.

[1] There is provided a gas separation membrane module assembly in which a plurality of flat separation membrane substrates and gas separation membranes are stacked via vacuum plates and seal rings, wherein a flow path forming member is provided, the flow path forming member being connected to both ends of one surface of the separation membrane substrate in one direction and having an opening portion which forms a gas flow path that extends in a direction approximately perpendicular to the one surface of the separation membrane substrate, and the vacuum plate and the seal ring are stacked on the flow path forming member so as to surround the opening portion.

According to the above aspect, it is possible to prevent uneven seal surface pressure and gas leakage. Furthermore, even when a thickness of the gas separation membrane module assembly increases, a seal ring can be disposed while gas leakage is curbed.

[2] In the gas separation membrane module assembly of [1], the vacuum plate may include a bolt fastening portion disposed within the opening portion.

According to the above aspect, by providing the bolt fastening portion within the opening portion of the flow path forming member, a seal surface pressure can be made uniform, and gas leakage can be curbed.

According to the aspect of the present invention, it is possible to provide a gas separation membrane module assembly in which occurrence of uneven seal surface pressure is curbed and gas leakage is curbed.

### BRIEF DESCRIPTION OF THE DRAWINGS

FIG. 1 is a perspective view showing a gas separation membrane module assembly according to one embodiment of the present invention.

FIG. 2 is a plan view showing the gas separation membrane module assembly according to the embodiment of the present invention.

FIG. 3 is a perspective view showing a part of the gas separation membrane module assembly according to the embodiment of the present invention.

FIG. 4 is a cross-sectional view showing a part of the gas separation membrane module assembly according to the embodiment of the present invention.

### DETAILED DESCRIPTION OF THE INVENTION

Hereinafter, an embodiment of the present invention will be described in detail with reference to the accompanying drawings.

### Gas separation membrane module assembly

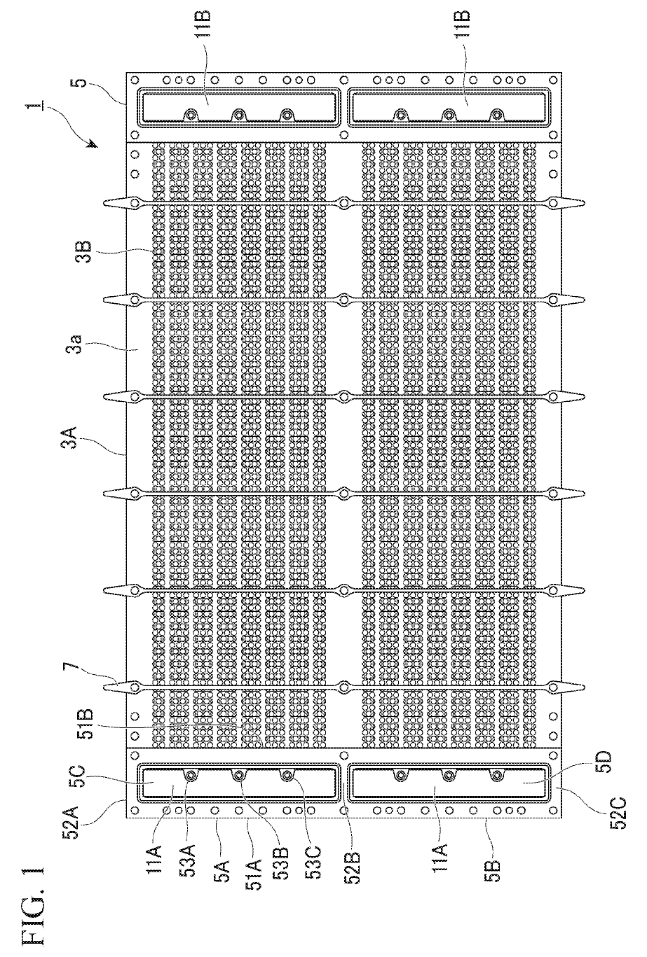

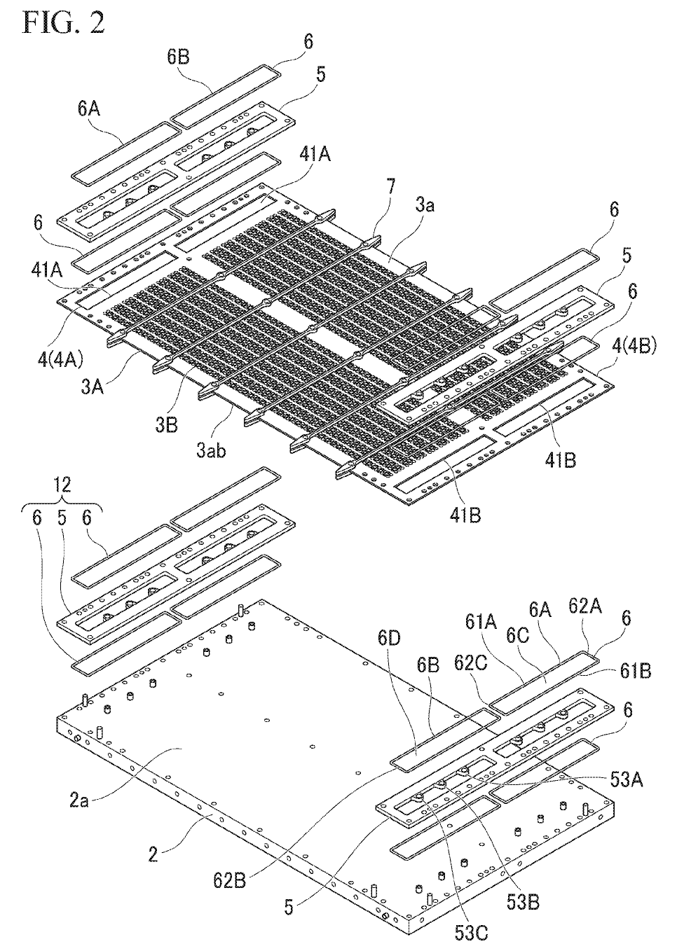

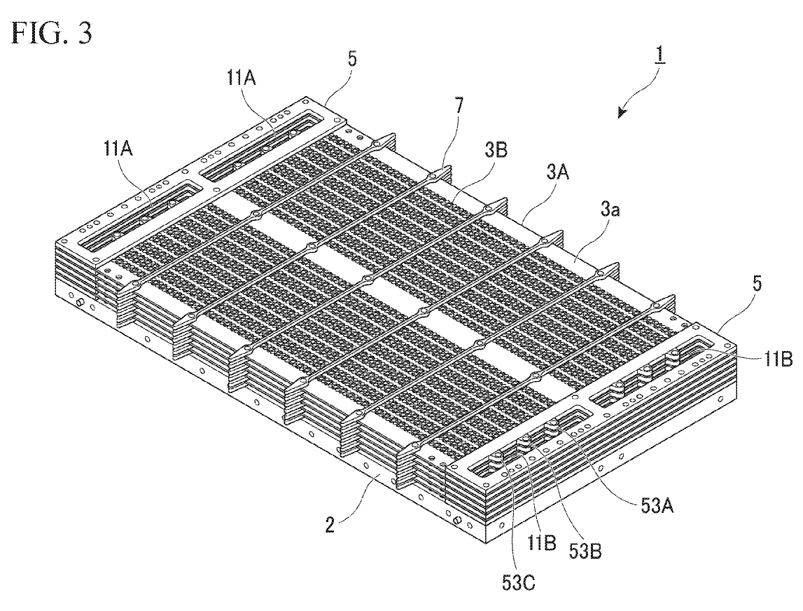

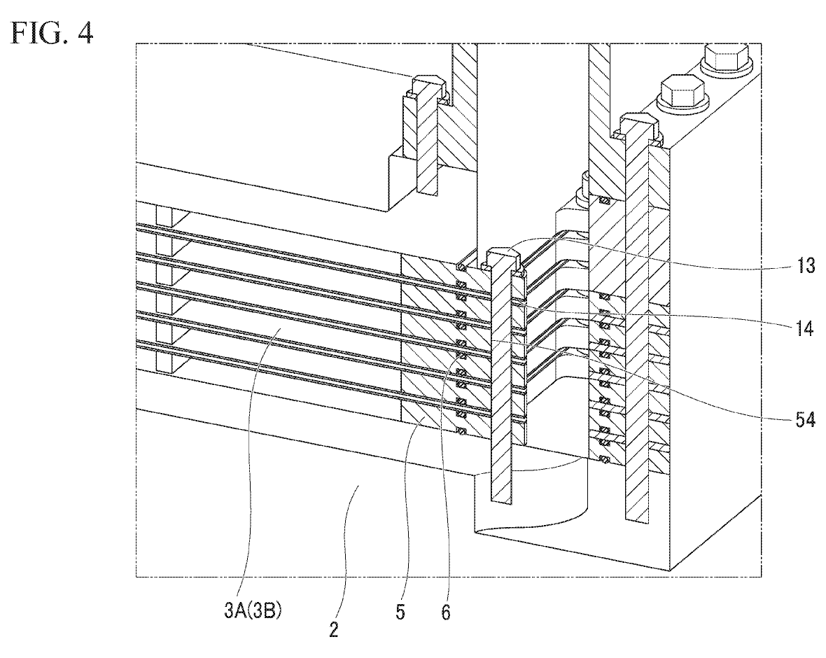

FIG. 1 is a perspective view showing a gas separation membrane module assembly according to an embodiment of the present invention. FIG. 2 is a plan view showing the gas separation membrane module assembly according to the embodiment of the present invention. FIG. 3 is a perspective view showing a part of the gas separation membrane module assembly according to the embodiment of the present invention. FIG. 4 is a cross-sectional view showing a part of the gas separation membrane module assembly according to the embodiment of the present invention.

As shown in FIGS. 1 to 4, the gas separation membrane module assembly 1 of this embodiment includes a module holder 2, a separation membrane substrate 3A and a gas separation membrane 3B, a flow path forming member 4, a vacuum plate 5, a seal ring 6, and a flow path spacer 7.

The separation membrane substrate 3A is formed of a corrosion-resistant material that is suitable for resisting corrosion caused by a waste gas. The gas separation membrane 3B is a flat gas separation membrane formed in a substantially rectangular flat plate shape. The gas separation membrane 3B is attached to one surface (a front surface in FIG. 2) 3a and the other surface (a back surface in FIG. 2) 3b of the separation membrane substrate 3A. The gas separation membrane 3B has a function of mainly allowing carbon dioxide contained in an exhaust gas to pass through. The gas separation membrane 3B is formed of an organic membrane that is mainly composed of an amino group and has a property of separating carbon dioxide from other gases using a solution-diffusion mechanism. As the gas separation membrane 3B, for example, an amino group-based organic membrane mainly made of polyamide, polyimide, or polysulfone can be used.

In the gas separation membrane module assembly 1 of this embodiment, a plurality of separation membrane substrates 3A and gas separation membranes 3B are stacked on one surface (an upper surface) 2a of the module holder 2 via the vacuum plates 5, the seal ring 6, and the flow path spacer 7.

The flow path forming members 4 are connected to both ends of one surface 3a of the separation membrane substrate 3A in one direction (in a longitudinal direction of the separation membrane substrate 3A in FIGS. 1 to 3). A first flow path forming member 4A of the flow path forming members 4, which is provided at one end of the separation membrane substrate 3A, has an opening portion 41A which forms a first gas flow path 11A that extends in a direction approximately perpendicular to the one surface 3a of the separation membrane substrate 3A. When the plurality of separation membrane substrates 3A are stacked, a plurality of first flow path forming members 4A are also stacked, and thus a plurality of opening portions 41A overlap each other in the direction approximately perpendicular to the one surface 3a of the separation membrane substrate 3A. Thus, the first gas flow path 11A that extends in the direction approximately perpendicular to one surface 3a of the separation membrane substrate 3A is formed by the plurality of opening portions 41A. Furthermore, among the flow path forming members 4, a second flow path forming member 4B provided at the other end of the separation membrane substrate 3A has an opening portion 41B which forms a second gas flow path 11B that extends in the direction approximately perpendicular to the one surface 3a of the separation membrane substrate 3A. When the plurality of separation membrane substrates 3A are stacked, a plurality of second flow path forming members 4B are also stacked, and thus a plurality of opening portions 41B overlap each other in the direction approximately perpendicular to the one surface 3a of the separation membrane substrate 3A. Thus, the second gas flow path 11B that extends in the direction approximately perpendicular to the one surface 3a of the separation membrane substrate 3A is formed by the plurality of opening portions 41B.

For example, the first gas flow path 11A is a flow path for introducing exhaust gas to be separated into a space between two gas separation membranes 3B adjacent to each other in the stacking direction. On the other hand, the second gas flow path 11B is a flow path for discharging carbon dioxide separated from the exhaust gas by the gas separation membrane 3B.

As shown in FIG. 3, a seal member 12 is formed by stacking a seal ring 6, a vacuum plate 5 and another seal ring 6 in this order. The vacuum plate 5 and the seal rings 6 (the seal member 12) are stacked on the first flow path forming member 4A and the second flow path forming member 4B so as to surround the opening portions 41A and 41B. The seal member 12 is interposed between two gas separation membranes 3B adjacent to each other in the stacking direction. In the seal members 12, the seal ring 6 is in contact with the gas separation membrane 3B.

As shown in FIG. 3, a plurality of flow path spacers 7 are disposed in one direction of the one surface 3a of the separation membrane substrate 3A (in FIGS. 1 to 3, the longitudinal direction of the separation membrane substrate 3A) and a vertical direction (in FIGS. 1 to 3, a longitudinal direction of the separation membrane substrate 3A) to come into contact with the one surface 3a and the other surface 3b of the separation membrane substrate 3A. The plurality of flow path spacers 7 are disposed at equal intervals on the one surface 3a and the other surface 3b of the separation membrane substrate 3A in the longitudinal direction of the one surface 3a of the separation membrane substrate 3A. By arranging the flow path spacer 7 in this manner, a space (a gas flow path) is provided between two gas separation membranes 3B adjacent to each other in the stacking direction. For example, exhaust gas can be introduced into the space from the first gas flow path 11A.

The vacuum plate 5 is made of a metal and is an annular member having a substantially rectangular exterior in plan view as shown in FIG. 3. The vacuum plate 5 has two long side portions 51A and 51B formed to face each other with a predetermined distance therebetween, and three short side portions 52A, 52B, and 52C formed at equal intervals in a direction perpendicular to the longitudinal direction of the long side portions 51A and 51B. The short side portions 52A and 52B are formed so as to connect both ends of the long side portions 51A and 51B in the longitudinal direction, respectively. The short side portion 52C is formed so as to connect centers of the long side portions 51A and 51B in the longitudinal direction. That is, the vacuum plate 5 is divided into two sections 5A and 5B via the short side portion 52C. The two sections 5A and 5B have the same shape. The vacuum plate 5 has three bolt fastening portions 53A, 53B, and 53C at equal intervals at an edge portion of the long side portion 51A that faces the long side portion 51B in each of the sections 5A and 5B. That is, the vacuum plate 5 has the bolt fastening portions 53A, 53B, and 53C in inner regions 5C and 5D of the vacuum plate 5. When the vacuum plate 5 is stacked on the one surface 3a of the gas separation membrane 3B so as to surround the opening portions 41A and 41B, the bolt fastening portions 53A, 53B, and 53C are disposed within the opening portions 41A and 41B.

Furthermore, when the plurality of separation membrane substrates 3A and gas separation membranes 3B are stacked, the plurality of vacuum plates 5 are also stacked, and thus, the bolt fastening portions 53A, 53B, and 53C provided on each of the vacuum plates 5 overlap each other in the direction approximately perpendicular to the one surface 3a of the separation membrane substrate 3A. Thus, a bolt fastening hole 54 that extends in the direction approximately perpendicular to the one surface 3a of the separation membrane substrate 3A is formed by the plurality of bolt fastening portions 53A, 53B, and 53C. By inserting bolts 13 into the bolt fastening holes 54 and tightening them with nuts (not shown), the plurality of separation membrane substrates 3A and gas separation membranes 3B are fixed in a stacked state onto one surface 2a of the module holder 2. Furthermore, a washer 14 is disposed between two adjacent bolt fastening portions 53A, 53B, and 53C.

The seal ring 6 is made of vulcanized rubber, a silicone ring, a liquid gasket, or the like. As shown in FIG. 3, the seal ring 6 is an annular member having a substantially rectangular exterior in plan view. The seal ring 6 has two long side portions 61A and 61B formed to face each other at a predetermined distance, and three short side portions 62A, 62B, and 62C formed at equal intervals in a direction perpendicular to the longitudinal direction of the long side portions 61A and 61B. The short side portions 62A and 62B are formed so as to connect both ends of the long side portions 61A and 61B in the longitudinal direction, respectively. The short side portion 62C is formed so as to connect centers of the long side portions 61A and 61B in the longitudinal direction. That is, the seal ring 6 is divided into two sections 6A and 6B via the short side portion 62C. The two sections 6A and 6B have the same shape. When the seal ring 6 is stacked on one surface 3a of the gas separation membrane 3B so as to surround the opening portions 41A and 41B, bolt fastening portions 53A, 53B, and 53C are disposed in inner regions 6C and 6D of the seal ring 6.

According to the gas separation membrane module assembly 1 of this embodiment, the seal surface pressure provided by the seal ring 6 can be made uniform, thereby curbing the occurrence of gas leakage. Furthermore, even when a thickness of the gas separation membrane module assembly 1 increases, the seal ring 6 can be disposed while gas leakage is curbed. Furthermore, by providing the bolt fastening portions 53A, 53B, and 53C in the opening portions 41A and 41B of the flow path forming member 4, the seal surface pressure by the seal ring 6 can be made uniform, and gas leakage can be curbed.

Although the embodiment of the present invention has been described in detail above, the present invention is not limited to the above embodiment, and various modifications and changes are possible within the scope of the gist of the present invention as described in the claims.

What is claimed is:

1. A gas separation membrane module assembly in which a plurality of flat separation membrane substrates and gas separation membranes are stacked via vacuum plates and seal rings,
wherein a flow path forming member is provided, the flow path forming member being connected to both ends of one surface of the separation membrane substrate in one direction and having an opening portion which forms a gas flow path that extends in a direction approximately perpendicular to the one surface of the separation membrane substrate, and
the vacuum plate and the seal ring are stacked on the flow path forming member so as to surround the opening portion.

2. The gas separation membrane module assembly according to claim 1, wherein the vacuum plate includes a bolt fastening portion disposed within the opening portion.
